(19) United States
(12) Patent Application Publication
(10) Pub. No.: US 2026/0020580 A1
(43) Pub. Date: Jan. 22, 2026

(54) METHOD FOR CONTROLLING DEGREE OF RIPENING OF FRUITS AND VEGETABLES PROVIDED WITH COATING FILM

(71) Applicant: Mitsubishi Chemical Corporation, Tokyo (JP)

(72) Inventors: Natsuki HIRA, Omihachiman-shi (JP); Atsushi TAKAKI, Yamato-shi (JP); Daichi NISHIMURA, Osaka (JP)

(73) Assignee: Mitsubishi Chemical Corporation, Tokyo (JP)

(21) Appl. No.: 19/340,713

(22) Filed: Sep. 25, 2025

Related U.S. Application Data
(63) Continuation of application No. PCT/JP2024/012487, filed on Mar. 27, 2024.

(30) Foreign Application Priority Data
Mar. 27, 2023 (JP) 2023-050596

(51) Int. Cl. A23B 7/16; A23B 7/154

(52) U.S. Cl. CPC A23B 7/16; A23B 7/154

(57) ABSTRACT

A method for controlling the ripening degree of a fruit/vegetable, the method including bringing a coated fruit/vegetable having a coating film formed on a surface, into contact with a ripening degree controlling substance, wherein the coating film contains a surfactant containing a long-chain aliphatic group in its chemical structure, and has a ratio of a total endothermic peak area A₁ in a range of 0° C. or higher and 40° C. or lower to a total endothermic peak area A₂ at 0° C. or higher and 80° C. or lower of 50% or less in differential scanning calorimetry with a measurement temperature range of 0° C. or higher. According to the present invention, it is possible to provide a method for controlling the ripening degree of a fruit/vegetable as necessary while keeping freshness of the fruit/vegetable.

### CROSS-REFERENCE TO RELATED APPLICATIONS

This application is a continuation of International Application PCT/JP2024/012487 filed on Mar. 27, 2024, and claims priority to Japanese application No. 2023-050596 filed on Mar. 27, 2023, the disclosures of all of which are incorporated herein by reference in their entireties.

### TECHNICAL FIELD

The present invention relates to a method for controlling the ripening degree of a coated fruit/vegetable.

### BACKGROUND ART

Saccharification proceeds with ripening progress in some fruits/vegetables, increasing their commercial value, but depending on the types of fruits/vegetables, some of them are strongly softened with saccharification, and therefore their mechanical strength is lowered, causing a problem in distribution. Specific examples of such fruits/vegetables include bananas and avocados, and these fruits/vegetables are harvested, distributed, and stored in an unripe state with high hardness for the reasons described above. Unripe fruits during storage are shipped after being subjected to a force-ripening treatment for accelerating the ripening progress and improving the ripening degree by ethylene treatment. Ethylene, which is a kind of plant hormone, is a substance that is gaseous at room temperature and is strongly involved in ripening of fruits/vegetables, and ripening can be forcibly advanced by bringing fruits/vegetables into contact with ethylene. The force-ripening treatment such as ethylene treatment is a very important treatment operation also from the economical viewpoint, because, when fruits/vegetables are shipped from a storage without ethylene treatment, it is not known at which timing appropriate ripening progress starts, and it may take a lot of time until they are brought into a state suitable for eating at a retail store or at a consumer's hand, or they may be in an overripe state.

On the other hand, ethylene is newly generated and released from fruits/vegetables whose ripening has progressed. Therefore, the progress of ripening affects other unripe fruits/vegetables as well in a chain reaction, and a plurality of individuals are softened, which may cause a problem in distribution. As a means for avoiding this, use of 1-methylcyclopropene (1-MCP) is exemplified. 1-MCP is a substance that is gaseous at room temperature, and has an action of inhibiting the physiological activity of ethylene by binding to an ethylene receptor in a plant body and antagonizing ethylene, and suppressing ripening of crops after harvest. This enables fruits/vegetables to be kept in an unripe state for a certain period without ripening progress thereof. The effective period varies depending on the fruit/vegetable.

In addition to the above-described ripening degree, it is also important to maintain the appearance of fruits/vegetables from the viewpoint of their commercial value. Since fruits/vegetables after harvest continue to lose moisture by transpiration, their commercial value is lowered due to wilting. For this reason, transpiration of many fruit/vegetable products is suppressed by using a packaging film.

However, ethylene is a substance that is gaseous at room temperature, and thus, when the target fruit/vegetable is covered with a packaging film or the like, ethylene does not sufficiently act because of insufficient permeation. Therefore, it is necessary to perform ethylene treatment before packaging, and moisture loss during the treatment is unavoidable. Alternatively, the packaged fruit/vegetable is once opened, treated with ethylene, and then packaged again.

On the other hand, Patent Literature 1 describes that a protective coating that slows down respiration is formed on a surface of an agricultural product, making it possible to lower the ripening rate of the agricultural product and to reduce moisture loss from the agricultural product. Patent Literature 1 describes that, for rapid ripening at an appropriate timing, the formed protective coating is removed.

### CITATION LIST

### Patent Literature

Patent Literature 1: JP 2019-527056 T

### SUMMARY OF INVENTION

### Technical Problem

However, the above method requires an additional cleaning step for removing the protective coating, and is not sufficient from an economic viewpoint, and there is room for improvement.

Accordingly, an object of the present invention is to provide a method for controlling the ripening degree of a fruit/vegetable as necessary while keeping freshness of the fruit/vegetable.

### Solution to Problem

The present inventors considered that combination of a protective coating for suppressing moisture loss and ethylene for promoting ripening progress is important, and studied various combinations. The inventors have found that the above problems can be solved by directly subjecting fruits/vegetables covered with a coating film containing a specific surfactant to a ripening degree control treatment.

That is, the present invention provides the following aspects.
[1] A method for controlling a ripening degree of a coated fruit/vegetable, the method including bringing a coated fruit/vegetable having a coating film formed on a surface, into contact with a ripening degree controlling substance, wherein the coating film contains a surfactant containing a long-chain aliphatic group in its chemical structure, and has a ratio of a total endothermic peak area A₁ in a range of 0° C. or higher and 40° C. or lower to a total endothermic peak area A₂ at 0° C. or higher and 80° C. or lower of 50% or less in differential scanning calorimetry with a measurement temperature range of 0° C. or higher.
[2] The method for controlling a ripening degree of a coated fruit/vegetable according to [1], wherein the surfactant is derived from a polyhydric alcohol.
[3] The method for controlling a ripening degree of a coated fruit/vegetable according to [1] or [2], wherein the surfactant includes a sugar-based surfactant.
[4] The method for controlling a ripening degree of a coated fruit/vegetable according to any one of [1] to [3], wherein the surfactant contains a sugar fatty acid ester.
[5] The method for controlling a ripening degree of a coated fruit/vegetable according to any one of [1] to [4], wherein the surfactant contains a sucrose fatty acid ester.
[6] The method for controlling a ripening degree of a coated fruit/vegetable according to any one of [1] to [5], wherein the long-chain aliphatic group of the surfactant is derived from a saturated aliphatic group.
[7] The method for controlling a ripening degree of a coated fruit/vegetable according to any one of [4] to [6], wherein the surfactant contains 50 mass % or more of a sugar fatty acid ester having 3 or less fatty acid ester groups, when a total amount of the surfactant is 100 mass %.
[8] The method for controlling a ripening degree of a coated fruit/vegetable according to any one of [1] to [7], wherein the surfactant has an HLB of 5 or more.
[9] The method for controlling a ripening degree of a coated fruit/vegetable according to any one of [1] to [8], wherein the coating film has an average film thickness of 0.1 μm or more and 10 μm or less.
[10] The method for controlling a ripening degree of a coated fruit/vegetable according to any one of [1] to [9], wherein the coating film has a ratio of a total exothermic peak area A₃ to the total endothermic peak area A₂ at 0° C. or higher and 80° C. or lower of 50% or less in differential scanning calorimetry with a measurement temperature range of −80° C. or higher.
[11] The method for controlling a ripening degree of a coated fruit/vegetable according to any one of [1] to [10], wherein the coating film has a crystal melting peak temperature of 40° C. or higher and 80° C. or lower.
[12] A method for controlling a ripening degree of a coated fruit/vegetable, wherein a coating film contains a surfactant containing a long-chain aliphatic group in a chemical structure of the surfactant, and has a ratio of a total exothermic peak area A₃ to a total endothermic peak area A₂ at 0° C. or higher and 80° C. or lower of 50% or less in differential scanning calorimetry with a measurement temperature range of −80° C. or higher.

### ADVANTAGEOUS EFFECTS OF INVENTION

According to the present invention, it is possible to provide a method for controlling the ripening degree of a fruit/vegetable as necessary while keeping freshness of the fruit/vegetable.

### DESCRIPTION OF EMBODIMENTS

### Coated Fruit/Vegetable

The coated fruit/vegetable of the present invention has a coating film on a surface of the fruit/vegetable.

The coating film does not necessarily cover the whole fruit/vegetable, and may cover only a part of the fruit/vegetable as long as transpiration from the fruit/vegetable can be suppressed.

### Fruit/Vegetable

The fruit/vegetable in the present invention is not particularly limited, but from the viewpoint that its commercial value can be increased or maintained at a high level by controlling its ripening degree, and that disposal loss can be reduced, fruits/vegetables exemplified below are indicated.

The control of the ripening degree includes both of control by reducing a ripening rate to extend an unripe period and control by increasing the ripening rate to ripen the fruit/vegetable. A treatment for increasing the ripening degree causes changes such as an increase in sugar content, a decrease in hardness, and a change in pericarp color.

Examples of the fruit/vegetable whose commercial value is improved by a force-ripening treatment include bananas, avocados, pears, European pears, kiwifruits, apples, persimmons, mangoes, papayas, umes, plums, apricots, melons, peaches, guavas, tomatoes (e.g., large tomatoes, medium tomatoes, and mini tomatoes), mandarin oranges, oranges, lemons, and potatoes.

Examples of the fruit/vegetable whose commercial value is maintained or improved by performing the control by reducing the ripening rate to extend the unripe period include bananas, avocados, pears, European pears, kiwifruits, apples, persimmons, mangoes, papayas, umes, apricots, melons, peaches, plums, guavas, tomatoes (e.g., large tomatoes, medium tomatoes, and mini tomatoes), and potatoes.

### Coating Film

The coating film according to the present invention contains a surfactant containing a long-chain aliphatic group in its chemical structure. The inclusion of the surfactant containing a long-chain aliphatic group in its chemical structure provides excellent water vapor barrier properties, and thus the transpiration from the fruit/vegetable can be suppressed and the freshness can be retained. On the other hand, the coating film of the present invention can reduce an amount of a ripening degree controlling substance to permeate therethrough. In other words, the coating film of the present invention has excellent water vapor barrier properties and can allow a small amount of the ripening degree controlling substance to permeate therethrough, and therefore, the ripening degree of the coated fruit/vegetable of the present invention can be controlled by a ripening degree control treatment.

A content of the surfactant containing a long-chain aliphatic group in its chemical structure in the coating film is preferably 60 mass % or more, more preferably 70 mass % or more, even more preferably 80 mass % or more, and still even more preferably 90 mass % or more, with 100 mass % as an upper limit. One of the surfactants containing long-chain aliphatic groups in their chemical structures may be used alone, or two or more thereof may be used in combination.

The coating film may be formed by solventless coating without a solvent, or may be formed of a composition containing a solvent.

In the present invention, from the viewpoint of keeping the freshness of the fruit/vegetable, the coating film preferably has water vapor barrier properties and/or oxygen barrier properties in order to suppress respiration and transpiration of moisture. In addition, from the viewpoint of safety when the coating film is used for food, the coating film is preferably edible.

### Differential Scanning Calorimetry at 0° C. or Higher

The coating film of the present invention has a ratio of a total endothermic peak area A₁ in a range of 0° C. or higher and 40° C. or lower to a total endothermic peak area A₂ at 0° C. or higher and 80° C. or lower of 50% or less in differential scanning calorimetry with a measurement temperature range of 0° C. or higher. The ratio is preferably 40% or less, more preferably 30% or less, and even more preferably 20% or less. The ratio may be 0%. When the ratio is within the above range, a proportion of phase change of the coating film is reduced within a practical temperature range in which fruits/vegetables not stored in a frozen state are stored, transported, and sold, and the phase change which affects the properties of the coating film does not occur. For example, freshness keeping functions such as water vapor barrier properties and oxygen barrier properties described later can be maintained. The peak area is defined as an area from a start point (rising position) to an end point (falling position) of each peak.

The temperature range for calculating A₁ is preferably 0° C. or higher and 35° C. or lower, more preferably 0° C. or higher and 30° C. or lower, and even more preferably 0° C. or higher and 25° C. or lower. This indicates that the temperature is within the practically preferable temperature range described above.

By setting the measurement temperature range to 0° C. or higher, it is possible to reflect the characteristics of the coating film in the practical temperature range in which fruits/vegetables not stored in a frozen state are stored, transported, and sold. For example, for a compound having a melting point of less than 0° C., it is possible to perform measurement reflecting a behavior of phase change from liquid to solid and behaviors such as crystallization of a component that is not crystallized and melting of a solid, by setting the measurement range to lower than 0° C., but these behaviors are not exhibited within the above-described practical temperature range, and it is difficult to say that the measurement reflects the behaviors in practical use.

As for A₁ and A₂, there may be a case where a plurality of peaks exist in each temperature range for calculating the total area, or only a part of the peak belongs to the temperature range. In this case, for all the peaks present in the temperature range, a total area of only portions belonging to the temperature range is calculated. For example, when one broad peak is present at 0 to 50° C., only portions at 0 to 40° C. are calculated as A₁.

Since it is considered that the surfactant used in the present invention has almost no peak in a temperature range of higher than 80° C., presumably, it is not necessary to consider the range of higher than 80° C. for A₂.

The differential scanning calorimetry with a measurement temperature range of 0° C. or higher is performed under the following conditions.
Measurement apparatus: differential scanning calorimeter
Measurement method: heat flux system
Temperature: 25° C.→0° C.→100° C.
Rate of temperature increase/decrease: 10° C./min
Atmosphere: nitrogen

Sample preparation: A surfactant-containing aqueous coating composition is placed in an empty aluminum pan so as to attain 1 mg in terms of dry solids content, and is allowed to stand still at room temperature to be dried, and it is confirmed that a weight variation from the previous day is 1% or less, thereby obtaining a sample to be measured.
Reference: aluminum pan

In the case of a sample in which no peak is observed when the temperature is increased or decreased at lower than 0° C., the temperature may be decreased from 25° C. to a temperature lower than 0° C. and then increased to 100° C. for measurement.

### Differential Scanning Calorimetry at −80° C. or Higher

The coating film of the present invention may have a ratio of a total exothermic peak area A₃ to the total endothermic peak area A₂ at 0° C. or higher and 80° C. or lower of 50% or less in differential scanning calorimetry with a measurement temperature range of −80° C. or higher. When the ratio is within the above range, stickiness of the coating film in a temperature range in which fruits/vegetables not stored in a frozen state are stored, transported, and sold can be suppressed to improve handleability, and furthermore, the freshness keeping functions such as water vapor barrier properties and oxygen barrier properties described later can be improved. The peak area is defined as an area from a start point (rising position) to an end point (falling position) of each peak.

The exothermic peak is considered to exhibit a behavior of phase change from a component that has not become a solid to a solid, or a behavior in which a component that has not crystallized crystallizes. On the other hand, the endothermic peak observed at 0° C. or higher is considered to be a peak derived from a behavior of phase change of a product obtained by solidifying all the components capable of becoming a solid in the coating film, for example, a behavior of melting a product obtained by crystallizing all the components capable of being crystallized in the coating film. Therefore, it is considered that the ratio of the total exothermic peak area A₃ to the total endothermic peak area A₂ at 0° C. or higher and 80° C. or lower indicates a ratio of the component that is not solid at 0° C. or higher in the coating film, for example, the component that is not crystallized. From the viewpoint of enhancing the above effect, the ratio is preferably 40% or less, more preferably 30% or less, and even more preferably 20% or less. Some exothermic peaks observed by a measurement method described later may be observed during temperature increase. This is considered to be due to the fact that a component in a supercooled state becomes solid, for example, exhibits a behavior of crystallization.

As for A₂ and A₃, there may be a case where a plurality of peaks exist in each temperature range for calculating the total area. In this case, for all the peaks present in the temperature range, a total area of only portions belonging to the temperature range is calculated. It is also possible, but unlikely, that there may be one peak in a temperature range that includes 0° C. In that case, it is determined whether the peak area is a part or all of A₂ and A₃ depending on whether the peak is an endothermic peak or an exothermic peak. Since it is considered that the surfactant used in the invention has almost no peak in a temperature range of lower than −80° C. and higher than 80° C., presumably, it is not necessary to consider the range of lower than −80° C. and higher than 80° C. for A₂ and A₃.

The differential scanning calorimetry with the measurement temperature range of −80° C. or higher is performed under the following conditions.
Measurement apparatus: differential scanning calorimeter
Measurement method: heat flux system
Temperature: 25° C.→−80° C.→100° C.
Rate of temperature increase/decrease: 10° C./min
Atmosphere: nitrogen

Sample preparation: A surfactant-containing aqueous coating composition is placed in an empty aluminum pan so as to attain 1 mg in terms of dry solids content, and is allowed to stand still at room temperature to be dried, and it is confirmed that a weight variation from the previous day is 1% or less, thereby obtaining a sample to be measured.
Reference: aluminum pan

### Crystallinity

The surfactant containing a long-chain aliphatic group in its chemical structure of the present invention preferably has crystallinity from the viewpoint of suppressing the stickiness of the resulting coating film and increasing the water vapor barrier properties.

A crystal melting peak temperature of the coating film containing the surfactant containing a long-chain aliphatic group in its chemical structure of the present invention is preferably 40° C. or higher and 80° C. or lower, and more preferably 45° C. or higher and 70° C. or lower. When the crystal melting peak temperature is 40° C. or higher, the stickiness of the resulting coating film can be suppressed. On the other hand, when the crystal melting peak temperature is 80° C. or lower, heating can be reduced in a case of dissolution in an aqueous solvent, and productivity becomes good.

The crystal melting peak temperature is a temperature at which a crystal melting peak is detected at the time of initial temperature increase from 30° C. to 100° C. in differential scanning calorimetry (DSC) in which measurement is performed at a heating rate of 10° C./min. When there are a plurality of crystal melting peaks, a total sum of peak areas in the above temperature range is preferably 50% or more with respect to a total sum of peak areas in the entire temperature region. In the measurement, the coating film may be formed on any substrate and then measured, or only the coating film may be measured. Examples of the substrate include a polyethylene terephthalate film and a glass plate.

In addition, the surfactant containing a long-chain aliphatic group in its chemical structure of the present invention contains a component that is solid at normal temperature (from 20 to 25° C.) in an amount of preferably 60 mass % or more, more preferably 70 mass % or more, even more preferably 80 mass % or more, and still even more preferably 90 mass % or more, from the viewpoint of suppressing the stickiness of the resulting coating film. The surfactant may be composed only of a component that is solid at normal temperature (from 20 to 25° C.), and therefore, the proportion may be 100 mass % or less.

### Water Vapor Barrier Properties

The coating film of the present invention has a water vapor transmission rate per μm at 30° C. and 80% RH of preferably from 0.1 to 20 cc/(m²·day·atm), more preferably from 0.5 to 17 cc/(m²·day·atm), and even more preferably from 1 to 15 cc/(m²·day·atm). When the water vapor transmission rate is within the above range, transpiration from the fruit/vegetable can be suppressed, and freshness can be kept.

The water vapor transmission rate (WVTR) can be measured by a differential pressure method using a water vapor transmission rate measuring apparatus DELTAPERM based on JIS K7129-5. More specifically, the water vapor transmission rate is a value obtained by converting a measured value of the water vapor transmission rate when film coating is performed on a polyethylene terephthalate film having a thickness of 50 μm under conditions of 30° C. and 80% RH into a transmission rate per μm by the following equation.

$$WVTR PER μm OF COATING FILM = \frac{( THICKNESS ( μm ) OF COATING FILM )}{( \frac{1}{WVTR OF COATED PET FILM )} - \frac{1}{( WVTR OF PET FILM )} )} \qquad [ Math . 1 ]$$

### Oxygen Barrier Properties

The coating film of the present invention has an oxygen transmission rate per μm at 25° C. and 50% RH of preferably from 0.1 to 100 cc/(m²·day·atm), more preferably from 0.5 to 90 cc/(m²·day·atm), and even more preferably from 1 to 50 cc/(m²·day·atm).

When the oxygen transmission rate is within the above range, aging of vegetables or fruits due to respiration can be suppressed, and freshness can be further kept.

The oxygen transmission rate (OTR) can be measured by an isobaric method using an oxygen transmission rate measuring apparatus OX-TRAN 2/21 (available from MOCON) based on JIS K7126-2. More specifically, the oxygen transmission rate is a value obtained by converting a measured value of the oxygen transmission rate when film coating is performed on a polyethylene terephthalate film having a thickness of 50 μm under conditions of 25° C. and 50% RH into a transmission rate per μm by the following equation.

$$OTR PER μm OF COATING FILM = \frac{( THICKNESS ( μm ) OF COATING FILM )}{( \frac{1}{OTR OF COATED PET FILM )} - \frac{1}{( OTR OF PET FILM )} )} \qquad [ Equation 2 ]$$

### Edibility

The coating film of the present invention preferably has edibility. The term “edibility” means that it can be used for food. From the viewpoint of safety, it is preferable to use a compound approved as a food additive so as to satisfy the dose, thereby making the compound edible.

### Average Film Thickness

An average film thickness of the coating film of the present invention is preferably 0.1 μm or more and 10 μm or less, and more preferably 0.5 μm or more and 5 μm or less. When the average film thickness is 0.1 μm or more, the water vapor barrier properties and the oxygen barrier properties are good. On the other hand, when the average film thickness is 10 μm or less, the coating film can be formed in a state where texture of the fruit/vegetable is kept.

In the present invention, the thickness of the coating film may not be uniform over the whole fruit/vegetable.

The average film thickness of the coating film can be determined from an arithmetic mean value of thicknesses measured at 10 or more randomly selected points of the coating film in a cross section of the coated fruit/vegetable through microscopic observation.

### Surfactant

The surfactant contained in the coating film of the present invention contains a long-chain aliphatic group in its chemical structure.

The surfactant is a substance which exhibits surface activity to lower surface tension of a solution used for dissolution, and is used in practice. The surfactant is roughly classified into four types of an anionic surfactant, a cationic surfactant, a nonionic surfactant, and an amphoteric surfactant.

The surfactant has a hydrophilic group and a lipophilic group. Examples of the hydrophilic group include a hydroxyl group, a carboxylic acid group, a sulfuric acid group, a phosphoric acid group, an amino group, and a quaternary ammonium group. The carboxylic acid group, the sulfuric acid group, the phosphoric acid group, the amino group, and the quaternary ammonium group may be in the form of a salt. Examples of the hydrophobic group include a hydrocarbon group, a fluorine group, and an organosilicon group.

The surfactant contained in the coating film of the present invention contains a long-chain aliphatic group in its chemical structure, and thus the coating film is likely to be solid at room temperature, and a coating film having excellent handleability can be formed. The long-chain aliphatic group is preferably a long-chain aliphatic hydrocarbon group. The number of carbon atoms of the long-chain aliphatic group is not particularly limited, but is preferably 12 or more and 22 or less, more preferably 12 or more and 18 or less, and even more preferably 14 or more and 18 or less. When the number of carbon atoms is within the above range, the stickiness of the resulting coating film can be suppressed.

As the surfactant used in a composition for forming the coating film of the present invention, an ester type or an ether type is preferable from the viewpoint of biodegradability.

As the ester type surfactant, a glycerin fatty acid ester and a sugar fatty acid ester are preferable from the viewpoint that they are approved as food additives.

As the ether type surfactant, an alkyl glycoside is preferable from the viewpoint that it is approved as a food additive.

Among these, a glycerin fatty acid ester and a sugar fatty acid ester are preferable from the viewpoint of being able to easily adjust hydrophilicity and hydrophobicity, and a sugar fatty acid ester is preferable from the viewpoint that it has high water solubility and can be dissolved in a solvent containing water as a main component and used.

Hereinafter, the alkyl glycoside and the sugar fatty acid ester are collectively referred to as sugar-based surfactant.

An HLB of the surfactant containing a long-chain aliphatic group in its chemical structure of the present invention is not particularly limited, but is preferably 5 or more, more preferably 7 or more, and even more preferably 9 or more, from the viewpoint of being able to form a coating film using an aqueous solvent described below. An upper limit of the HLB is usually 20, and more preferably 18 or less.

### Long-Chain Fatty Acid

When the long-chain aliphatic group of the surfactant contained in the coating film of the present invention is derived from a long-chain fatty acid, that is, when a constituent fatty acid of the surfactant is a long-chain fatty acid, the long-chain fatty acid is preferably an edible oil and/or fat. The surfactant having a long-chain aliphatic group derived from a long-chain fatty acid is hereinafter also referred to as a long-chain fatty acid-based surfactant.

The number of carbon atoms of the long-chain fatty acid which is a constituent fatty acid of the surfactant of the present invention is not particularly limited, but is preferably 12 or more and 22 or less, more preferably 12 or more and 18 or less, and even more preferably 14 or more and 18 or less. When the number of carbon atoms is within the above range, the stickiness of the resulting coating film can be suppressed.

The long-chain fatty acid which is a constituent fatty acid of the surfactant of the present invention may be a saturated or unsaturated fatty acid, but is preferably a saturated fatty acid from the viewpoint that it is likely to be solid at normal temperature (from 20 to 25° C.) and can suppress the stickiness of the resulting coating film.

More specific examples of the saturated fatty acid include lauric acid, myristic acid, pentadecylic acid, palmitic acid, palmitoleic acid, margaric acid, stearic acid, and oleic acid, and among these, lauric acid, myristic acid, palmitic acid, and stearic acid, which are saturated fatty acids having 12 or more and 18 or less carbon atoms, are preferable, and myristic acid, palmitic acid, and stearic acid, which are saturated fatty acids having 14 or more and 18 or less carbon atoms, are more preferable. One of these saturated fatty acids may be used alone, or two or more thereof may be used in combination.

It is not necessary that all the long-chain fatty acids as constituent fatty acids of the surfactant of the present invention be the same, and the above-described suitable constituent fatty acids account for 60 mass % or more of the long-chain fatty acids as constituent fatty acids in the surfactant. From the viewpoint of suppressing the stickiness of the resulting coating film, this proportion is preferably 70 mass % or more, more preferably 80 mass % or more, and even more preferably 90 mass % or more. In addition, an upper limit is not particularly limited, and may be 100 mass % or less.

The constituent fatty acid composition of the surfactant can be measured by isolating a sugar fatty acid ester from a composition, derivatizing the sugar fatty acid ester, and analyzing the derivatized sugar fatty acid ester by gas chromatography.

### Polyhydric Alcohol

The surfactant containing a long-chain aliphatic group in its chemical structure of the present invention is preferably derived from a polyhydric alcohol. The polyhydric alcohol is an alcohol having two or more hydroxyl groups in its molecule. In addition, the phrase “derived from a polyhydric alcohol” means that the structure is obtained by reacting a polyhydric alcohol, and means, for example, an ether or ester of a polyhydric alcohol.

When the surfactant is derived from a polyhydric alcohol, the surfactant can have a structure having a plurality of long-chain aliphatic groups, and the physical properties can be easily adjusted.

Examples of the polyhydric alcohol include dihydric alcohols such as ethylene glycol, 1,2-propylene glycol, 1,3-propylene glycol, and polyethylene glycol; trihydric alcohols such as glycerin; tetrahydric alcohols such as erythritol; tetrahydric or higher alcohols such as polyglycerin; sugars; and sugar alcohols obtained by reducing sugars, such as sorbitol and xylitol.

That is, the polyhydric alcohol-derived surfactant of the present invention may be a sugar-based surfactant, a glycerin fatty acid ester, or the like.

### Sugar-Based Surfactant

The surfactant containing a long-chain aliphatic group in its chemical structure of the present invention may contain a sugar-based surfactant.

The sugar-based surfactant is a surfactant having sugars such as a monosaccharide, a disaccharide, a trisaccharide, a tetrasaccharide, a polysaccharide, a sugar alcohol, and other oligosaccharides as hydrophilic groups, and examples thereof include a sugar fatty acid ester formed of a sugar and a fatty acid linked via an ester bond, and an alkyl glycoside formed of a sugar and a higher alcohol linked via a glycoside bond, and among these, a sugar fatty acid ester is preferable from the viewpoint of film formability.

The sugar-based surfactant preferably has crystallinity from the viewpoint of being able to suppress the stickiness of the resulting coating film and to increase the water vapor barrier properties and the oxygen barrier properties.

In addition, the sugar-based surfactant contains a component that is solid at normal temperature (from 20 to 25° C.) in an amount of preferably 60 mass % or more, more preferably 70 mass % or more, even more preferably 80 mass % or more, and still even more preferably 90 mass % or more, from the viewpoint of the suppressing the stickiness of the resulting coating film. The sugar-based surfactant may be composed only of a component that is solid at normal temperature (from 20 to 25° C.), and therefore, the proportion may be 100 mass % or less.

An HLB of the sugar-based surfactant is not particularly limited, but is preferably 5 or more, more preferably 7 or more, and even more preferably 9 or more, from the viewpoint of being able to form a coating film using an aqueous solvent described below. An upper limit of the HLB is usually 20, and more preferably 18 or less.

### Sugar Fatty Acid Ester

The surfactant containing a long-chain aliphatic group in its chemical structure of the present invention may contain a sugar fatty acid ester. The sugar-based surfactant of the present invention may contain a sugar fatty acid ester.

The sugar fatty acid ester is formed of a sugar and a fatty acid linked via an ester bond.

The sugar in the sugar fatty acid ester may be any of a monosaccharide, a disaccharide, a trisaccharide, a tetrasaccharide, a polysaccharide, a sugar alcohol, and other oligosaccharides.

Examples of the monosaccharide include pentoses such as ribulose, xylulose, ribose, arabinose, xylose, lyxose, and deoxyribose; and hexoses such as psicose, fructose, sorbose, tagatose, allose, altrose, glucose, mannose, gulose, idose, galactose, talose, fucose, fuculose, and rhamnose.

Examples of the disaccharide include sucrose, lactose, maltose, trehalose, turanose, and cellobiose.

Examples of the trisaccharide include raffinose, melezitose, and maltotriose.

Examples of the tetrasaccharide include acarbose and stachyose.

Examples of the polysaccharide include glycogen, starch, cellulose, dextrin, glucan, fructan, and chitin.

Examples of the sugar alcohol include sorbitol, erythritol, xylitol, maltitol, lactitol, mannitol, and glycerin, and the sugar alcohol may be a condensate of these sugar alcohols.

Examples of the other oligosaccharides include fructooligosaccharide, galactooligosaccharide, mannanoligosaccharide, and lactosucrose.

The constituent fatty acid of the sugar fatty acid ester is as described in the above Fatty Acid section.

The constituent fatty acids of the sugar fatty acid ester do not need to be all the same, and the above-described suitable constituent fatty acids account for 60 mass % or more of the constituent fatty acids in the sugar fatty acid ester. From the viewpoint of suppressing the stickiness of the resulting coating film, this proportion is preferably 70 mass % or more, more preferably 80 mass % or more, and even more preferably 90 mass % or more. In addition, an upper limit is not particularly limited, and may be 100 mass % or less.

The constituent fatty acid composition of the sugar fatty acid ester can be measured by isolating a sugar fatty acid ester from a composition, derivatizing the sugar fatty acid ester, and analyzing the derivatized sugar fatty acid ester by gas chromatography.

The range of the number of fatty acid ester groups of the sugar fatty acid ester varies depending on the number of hydroxyl groups capable of forming an ester bond in the molecular structure of the sugar which is a hydrophilic group, and is, for example, from 1 to 8 in the case of a sucrose fatty acid ester and from 1 to 4 in the case of a sorbitan fatty acid ester.

From the viewpoint of dispersibility or solubility in an aqueous solvent, when a total amount of the sugar-based surfactant is 100 mass %, a sugar fatty acid ester (a monoester, a diester, or a triester) having 3 or less fatty acid ester groups is contained in an amount of preferably 50 mass % or more, more preferably 60 mass % or more, and even more preferably 70 mass % or more. In addition, an upper limit is not particularly limited, and may be 100 mass % or less.

From the same viewpoint, when the total amount of the sugar-based surfactant is 100 mass %, a sugar fatty acid ester having 6 or more fatty acid ester groups (a hexaester, a heptaester, an octaester, or a higher ester) is contained in an amount of preferably 30 mass % or less, more preferably 20 mass % or less, and even more preferably 10 mass % or less. The sugar fatty acid ester having 6 or more fatty acid ester groups may not be contained, and a content thereof may be 0 mass % or more.

A content proportion of each number of fatty acid ester groups can be measured according to METHOD OF ASSAY described in Residue Monograph prepared by the meeting of the Joint FAO/WHO Expert Committee on Food Additives (JECFA), 84th meeting 2017 “Sucrose Esters of Fatty Acids” and Prepared at the 71st JECFA (2009) and published in FAO JECFA Monographs 7 (2009), “Sucrose Oligoesters Type I” and “Sucrose Oligoesters Type II”, after isolation of the sugar fatty acid ester from a composition.

### Measurement of Monoester to Triester and Tetraester and Higher Ester

A sample is dissolved in a certain amount of tetrahydrofuran (stabilizer-containing GPC or industrial grade), and then a solution obtained by removing insoluble matter with a 0.5-μm membrane filter is used as a measurement sample, and high-performance liquid chromatography is performed under the following conditions. A compositional proportion is obtained by individually calculating a peak area of each of the monoester to the triester and a total peak area of the tetraester and higher esters, and calculating proportions of these peak areas to a total peak area of all the peaks detected up to 43 minutes.

The peak area is defined as an area from a start point (rising position) to an end point (falling position) of each peak.

When two or more peaks are adjacent to each other and the start point and the end point are unknown, the area is calculated by using a point at which data between the peaks is minimized as the start point and the end point.

### Measurement Conditions: Monoester to Triester and Tetraester and Higher Ester

Apparatus: HLC-8320GPC detector: differential refractometer (available from Tosoh Corporation)
Column: TSK-gel G1000HXL, G2000HXL, G3000HXL, G4000HXL (available from Tosoh Corporation)
Column temperature: 40° C.
Detector temperature: 40° C.
Eluent: tetrahydrofuran (stabilizer-containing GPC or industrial grade)
Flow rate: 0.8 ml/min
Injection volume: 80 μl
Measurement time: 50 minutes (area ratio is calculated based on all peaks detected up to 43 minutes)

### Measurement of Tetraester to Octaester

A sample is dissolved in a certain amount of methanol (special grade reagent)/tetrahydrofuran (stabilizer-free HPLC grade)=20/80 (vol/vol), and then a solution obtained by removing insoluble matter with a 0.45-μm membrane filter is used as a measurement sample, and high-performance liquid chromatography is performed under the following conditions. A compositional proportion of the tetraester to octaester is calculated by individually calculating a peak area of each of the tetraester to the octaester, calculating a proportion of the peak area to a total peak area of the tetraester to the octaester, and proportionally dividing the area proportion of the tetraester and higher esters determined in the above Measurement of Monoester to Triester and Tetraester and Higher Ester by the area proportion of the tetraester to the octaester.

The peak area is defined as an area from a start point (rising position) to an end point (falling position) of each peak.

When two or more peaks are adjacent to each other and the start point and the end point are unknown, the area is calculated by using a point at which data between the peaks is minimized as the start point and the end point.
Measurement Conditions: Tetraester to Octaester Apparatus
Degasser: DGU-20A (available from Shimadzu Corporation)
Pump: LC-20AD (available from Shimadzu Corporation)
Oven: CTO-20A (available from Shimadzu Corporation)
Detector: RID-20A differential refractometer (available from Shimadzu Corporation)
Column: 150 mm×4.6 mm i.d.; ODS-2 (available from GL Sciences Inc.)
Column temperature: 40° C.
Detector temperature: 40° C.
Eluent: methanol (special grade reagent)/tetrahydrofuran (stabilizer-free HPLC grade)=from 70/30 to 50/50 (vol/vol)
Flow rate: 0.8 ml/min
Injection volume: 20 μl
Measurement time: 16 minutes

The sugar fatty acid ester is not particularly limited as long as it can be used in food, and examples thereof include sucrose fatty acid esters, sorbitan fatty acid esters, and glucose esters, and among these, sucrose fatty acid esters are preferable from the viewpoint of availability.

One of the sugar-based surfactants is not necessarily used alone, and two or more thereof may be used in combination. In a case where two or more types are combined, the sucrose fatty acid ester preferably accounts for 60 mass % or more when a total amount of the sugar-based surfactant is 100 mass %. This ratio is more preferably 70 mass % or more, even more preferably 80 mass % or more, and still even more preferably 90 mass % or more, from the viewpoint of being able to suppress the stickiness of the resulting coating film and to increase the water vapor barrier properties and the oxygen barrier properties. The sucrose fatty acid ester may be used alone in the sugar-based surfactant, and therefore the above proportion may be 100 mass % or less.

### Glycerin Fatty Acid Ester

The surfactant containing a long-chain aliphatic group in its chemical structure of the present invention may contain a glycerin fatty acid ester.

The glycerin fatty acid ester is formed of glycerin and a fatty acid linked via an ester bond.

As the fatty acid constituting the glycerin fatty acid ester, the same fatty acid as the fatty acid constituting the sugar fatty acid ester is preferable.

The number of fatty acid ester groups of the glycerin fatty acid ester is from 1 to 3. From the viewpoint of dispersibility in an aqueous solvent, viscosity of the composition, and handling, the glycerin fatty acid ester (triester) having one fatty acid ester group is contained in an amount of preferably 50 mass % or more, more preferably 60 mass % or more, and even more preferably 70 mass % or more, when a total amount of the glycerin fatty acid ester is 100 mass %. In addition, an upper limit is not particularly limited, and may be 100 mass % or less.

The type and amount of fatty acid can be analyzed by column chromatography, gas chromatography, thin layer chromatography, high-performance liquid chromatography, colorimetry, or the like.

### Covering Agent Composition

The coating film according to the present invention may be formed of a covering agent composition. The covering agent composition contains the surfactant containing a long-chain aliphatic group in its chemical structure as described above.

An additional component is not particularly limited as long as the coating film formed using the covering agent composition exhibits the effects of the present invention. As described above, it is preferable that a coating film having water vapor barrier properties and/or oxygen barrier properties can be formed. Therefore, the covering agent composition may contain one or more of a water-soluble polymer, an inorganic filler, and a surfactant other than the surfactant containing a long-chain aliphatic group in its chemical structure. Examples of these components include polysaccharides, polyvinyl alcohol, polyvinyl pyrrolidone, polyacrylic acid, clay, and surfactants other than the surfactant containing a long-chain aliphatic group in its chemical structure.

### Aqueous Solvent

The covering agent composition according to the present invention preferably contains an aqueous solvent from the viewpoint of application efficiency. The aqueous solvent constituting the covering agent composition is water or a mixed solvent of water and one or more water-soluble organic solvents. Examples of the water-soluble organic solvent include alcohols such as ethanol, isopropanol, ethylene glycol, and glycerin. From the viewpoint of applicability to fruits/vegetables, water is preferably used, but from the viewpoint of stability and applicability of the covering agent composition, the organic solvent such as alcohol as described above may be contained as a solvent in addition to water. Covering agent compositions containing water are also referred to as aqueous coating compositions.

A content of the organic solvent in the aqueous solvent is preferably 30 mass % or less, more preferably 20 mass % or less, even more preferably 10 mass % or less, and still even more preferably 5 mass % or less.

### Additional Component

The covering agent composition according to the present invention may contain an additional component in an amount that does not impair the function of the covering agent of the present invention. Examples of the additional component include a pH adjuster.

As the pH adjuster, for example, acetic acid, lactic acid, citric acid, ammonia, or the like can be used.

From the viewpoint of improving solubility in the aqueous solvent, a fatty acid salt or a surfactant of a different type may be used in combination.

### Nonvolatile Component Concentration

A nonvolatile component concentration of the covering agent composition according to the present invention is not particularly limited, but is preferably 0.1 mass % or more and 60 mass % or less, more preferably 0.2 mass % or more and 50 mass % or less, even more preferably 0.3 mass % or more and 40 mass % or less, still even more preferably 0.5 mass % or more and 20 mass % or less, and particularly preferably 1 mass % or more and 10 mass % or less. When the nonvolatile component concentration is 0.1 mass % or more and 60 mass % or less, a coating film having a suitable film thickness is easily formed while the surfactant of the present invention is appropriately dissolved in the aqueous solvent.

The term “nonvolatile component concentration” in the present invention is a concentration of nonvolatile components excluding the solvent contained in the covering agent composition.

### Content of Surfactant

A content of the surfactant containing a long-chain aliphatic group in its chemical structure according to the present invention in the covering agent composition is preferably 60 mass % or more, more preferably 70 mass % or more, even more preferably 80 mass % or more, and particularly preferably 90 mass % or more, with 100 mass % as an upper limit, of the nonvolatile components in the covering agent composition, from the viewpoint of being able to increase the water vapor barrier properties and oxygen barrier properties of the resulting coating film.

Since the coating film in the present invention is obtained by volatilizing the solvent from the composition, a suitable content of the surfactant containing a long-chain aliphatic group in its chemical structure in the coating film is also the same as described above.

### pH of Covering Agent Composition

A pH of the covering agent composition is preferably 4 or more and 10 or less, and more preferably 4 or more and 8 or less, from the viewpoint that the composition can be safely applied to fruits/vegetables.

### Application of Covering Agent Composition

The covering agent composition to be applied to form the coating film of the present invention is applied to the fruits/vegetables described in the Fruit/Vegetable section.

As the state of the fruits/vegetables, the application may be made to ripe fruits/vegetables or to fruits/vegetables harvested earlier before ripe.

The covering agent composition may be applied to the whole or a part of the fruit/vegetable. When the covering agent composition is applied to a part of the fruit/vegetable, an amount of the covering agent composition to be used can be necessary minimum.

When the covering agent composition is applied to a part of the fruit/vegetable, an application area is preferably 10% or more, more preferably 25% or more, even more preferably 40% or more, and still even more preferably 50% or more, relative to a surface area of the whole fruit/vegetable.

After the covering agent composition is applied to the fruit/vegetable, a part of the applied covering agent composition may be removed. The removal method is not particularly limited, and examples thereof include removal by wind pressure using an air dryer. By removing an excess covering agent composition on the surface of the fruit/vegetable, it is possible to prevent the portion applied in an excessive amount from being poorly dried.

Since the target of the present invention is a fruit/vegetable, the freshness can be kept by covering at least a site with a large amount of moisture transpiration, and therefore the composition in the other portion may be removed.

The example of the application method is described in “Coating System”, Yuji Harazaki, Maki Shoten, published in 1979.

### Drying

After the covering agent composition is applied to the fruit/vegetable, the coating film may be dried for the purpose of removing the aqueous solvent, or the like. Examples of the drying method include static drying, air drying, and heat drying, and from the viewpoint of keeping the freshness of the fruit/vegetable, a method of static drying at room temperature (from 20 to 25° C.) or a method of air drying at room temperature is preferable.

### Solventless Application of Surfactant

When the surfactant is applied to the fruit/vegetable in a solventless manner, a method is preferable in which the surfactant is heated to a temperature at which the surfactant exhibits fluidity (for example, a temperature from a melting point of the sugar-based surfactant to the melting point+30° C.), and then applied to the fruit/vegetable by curtain coating, spray coating, or the like. In the case of solventless application, a surfactant alone may be applied to the fruit/vegetable, or a surfactant appropriately mixed with an additional component (such as nonvolatile components) other than the solvent may be applied.

From the viewpoint of increasing the efficiency of coating film formation treatment, the surfactant may be applied to a part of the fruit/vegetable. After the surfactant is applied to the fruit/vegetable, an excess of the applied surfactant may be removed.

### Method for Controlling RipeningDegree

The method for controlling the ripening degree of a coated fruit/vegetable according to the present invention is performed on the coated fruit/vegetable as described above. The coating film has a ratio of a total endothermic peak area A₁ in a range of 0° C. or higher and 40° C. or lower to a total endothermic peak area A₂ at 0° C. or higher and 80° C. or lower of 50% or less in differential scanning calorimetry with a measurement temperature range of 0° C. or higher. A preferred range of the ratio is as described above. The method for controlling the ripening degree of a coated fruit/vegetable according to the present invention is performed on the coated fruit/vegetable, wherein the coating film has a ratio of a total exothermic peak area A₃ to the total endothermic peak area A₂ at 0° C. or higher and 80° C. or lower is 50% or less in differential scanning calorimetry with a measurement temperature range of −80° C. or higher.

This makes it possible to control the ripening degree of the fruit/vegetable as necessary while keeping the freshness of the fruit/vegetable, to easily provide a quantity of fruits/vegetables required according to the market demand, and to reduce waste loss due to excessive ripening.

The method for controlling the ripening degree of the present invention includes both of a control by reducing the ripening rate to extend the unripe period and a control by increasing the ripening rate to advance ripening.

Specifically, the method for controlling the ripening degree can be performed by bringing a fruit/vegetable having a coating film into contact with (exposing a fruit/vegetable having a coating film to) a ripening degree controlling substance. It is possible to make the ripened state of the fruit/vegetable uniform and to consequently make the quality of commodities uniform by keeping a concentration of the ripening degree controlling substance to be brought into contact with the fruit/vegetable constant when performing a ripening degree control treatment. Therefore, an environment in which ethylene is brought into contact is preferably a sealed space. Even when the space is not a sealed space, the concentration of the ripening degree controlling substance in the space may be monitored and controlled to be constant. At this time, the fruit/vegetable having a coating film may be brought into contact with a gas containing the ripening degree controlling substance, or the fruit/vegetable having a coating film may be brought into contact with a liquid containing the ripening degree controlling substance. The liquid containing the ripening degree controlling substance may be a solution of the ripening degree controlling substance in a solvent. The liquid is preferably an aqueous solvent, and examples thereof include the same aqueous solvents as those contained in the covering agent composition.

It is preferable to bring the fruit/vegetable having a coating film into contact with a gas containing the ripening degree controlling substance, from the viewpoint that this method is used for general purposes.

The method of bringing the fruit/vegetable having a coating film into contact with the gas containing the ripening degree controlling substance is, for example, a method of carrying the fruit/vegetable having a coating film into a space where temperature and humidity are managed, introducing the ripening degree controlling substance into the space so as to attain a predetermined concentration, and bringing the fruit/vegetable having a coating film into contact with the ripening degree controlling substance for a predetermined time.

The compound that advances ripening is preferably a compound that is gaseous at room temperature from the viewpoint of handleability and from the viewpoint of uniformly acting on the fruit/vegetable in a short time, and examples thereof include ethylene and propylene having a structure similar to that of ethylene. In addition, a precursor compound that generates ethylene gas by being decomposed by water or heat may be used. Examples of the compound that is decomposed by water include 2-chloroethylphosphonic acid. The ethylene gas is preferably used from the viewpoint that it is not necessary to undergo a reaction from the precursor compound, that the concentration is easily controlled, and that the effect is obtained with a small amount.

In the case of performing a force-ripening treatment using ethylene or the like, when the concentration of ethylene in contact with the fruit/vegetable is not constant, the ripening state of the fruit/vegetable varies, and the quality of the products varies. Therefore, the environment in which ethylene is brought into contact is preferably a sealed space. Even when the space is not a sealed space, the concentration of ethylene in the environment may be monitored and controlled to be constant.

It is known that a rate of ripening progress affects temperature and humidity environments in which the force-ripening treatment is carried out. For example, with respect to humidity, it is found that the ripening proceeds faster when ethylene is brought into contact in a low-humidity environment (Nippon Shokuhin Kagaku Kogaku Kaishi Vol. 43, No. 5, 541 to 545, 1996). In addition, it is found that the higher the temperature, the faster the ripening progresses (J. Japan. Soc. Hort. Sci. 55 (3): 348-354. 1986). An appropriate rate of ripening progress can be adjusted depending on the transport time after the ethylene treatment and the shelf life period at the store.

The concentration of the compound that advances ripening varies depending on the type of fruit/vegetable and the desired ripening progress rate, but for example, in the case of bringing ethylene into contact with bananas, the concentration is 1000 ppm at 20° C. (JP 2002-136257 A). An appropriate rate of ripening progress can be adjusted depending on the transport time after the ethylene treatment and the shelf life period at the store.

Examples of the contact method using ethylene include a method in which ethylene gas is introduced from an ethylene gas high-pressure cylinder into a storage warehouse of unripe bananas or the like so as to attain an appropriate concentration through decompression or the like to ripen the bananas, a method in which ethylene gas is once adsorbed to an adsorption porous body, the ethylene gas-adsorbed porous body is put in a film pack made of an aluminum foil or the like, and the film pack is opened in a ripening chamber to diffuse the ethylene gas (JP 64-85064 A) and a method in which ethylene gas is generated by a dehydration reaction of ethyl alcohol (JP 2-157232 A and JP 4-117239 A).

As the compound that lowers the ripening rate, 1-MCP is preferably used from the viewpoint of highly exhibiting the target effect to be exhibited with respect to the amount to be used. 1-MCP has an action of inhibiting the physiological activity of ethylene by binding to an ethylene receptor in a plant body and antagonizing ethylene, and suppressing ripening of crops after harvest.

The method of contact with 1-MCP includes fumigation using a fumigant. The concentration, temperature and humidity, and contact time may be appropriately changed depending on the fruit/vegetable, the ripening degree of the fruit/vegetable, the type and thickness of the coating film, and the like.

The 1-MCP can also be adjusted depending on the transport time after the treatment and the shelf life period at the store. When the effect is lost in a certain period after the treatment, the treatment may be performed a plurality of times in a plurality of steps such as before storage and before shipment.

When the coated fruit/vegetable is brought into contact with the ripening degree controlling substance, the fruit/vegetable is stored at a first temperature for any period after the coating film is formed on the fruit/vegetable, and then the contact is performed at a second temperature.

The storage period at the first temperature is any period and may be optional, and may be determined according to the desired storage period. The first temperature and the second temperature may be equal to or different from each other. The first temperature is preferably not lower than a temperature at which the fruit/vegetable is not frozen. The first temperature is preferably not higher than a temperature at which the ripening of the fruit/vegetable does not excessively proceed. The temperature at which the fruit/vegetable is not frozen is, for example, 0° C. or higher. The temperature at which the ripening of the fruit/vegetable does not excessively proceed is, for example, 40° C. or lower, more preferably 35° C. or lower, even more preferably 30° C. or lower, and particularly preferably 25° C. or lower.

The second temperature is preferably not lower than a temperature at which the fruit/vegetable is not frozen. The second temperature is preferably not higher than a temperature at which the ripening of the fruit/vegetable does not excessively proceed. These temperature ranges may be the same as those described for the first temperature. For example, the coated fruit/vegetable stored at room temperature may be brought into contact with the ripening degree controlling substance at room temperature, the coated fruit/vegetable stored at 0° C. may be brought into contact with the ripening degree controlling substance at 0° C., the coated fruit/vegetable stored at 0° C. may be brought into contact with the ripening degree controlling substance at room temperature, or the coated fruit/vegetable stored at room temperature may be brought into contact with the ripening degree controlling substance at 0° C.

The coated fruit/vegetable may be subjected to a plurality of temperature conditions, in which case each temperature condition is preferably within the preferred range of the first temperature after the coating film is formed on the fruit/vegetable.

### EXAMPLES

Next, the present invention will be described in more detail below by way of Examples. However, the present invention will be described below. The present invention is not limited to the Examples.

### Differential Scanning Calorimetry at 0° C. or Higher

The differential scanning calorimetry with a measurement temperature range of 0° C. or higher is performed under the following conditions.
Measurement apparatus: NETZSCH DSC 204F1
Measurement method: heat flux system
Temperature: 25° C.→0° C.→100° C.
Rate of temperature increase/decrease: 10° C./min
Atmosphere: nitrogen

Sample preparation: A surfactant-containing aqueous coating composition is placed in an empty aluminum pan so as to attain 1 mg in terms of dry solids content, and is allowed to stand still at room temperature to be dried, and it is confirmed that a weight variation from the previous day is 1% or less, thereby obtaining a sample to be measured.
Reference: aluminum pan

### Differential Scanning Calorimetry at −80° C. or Higher

The differential scanning calorimetry with the measurement temperature range of −80° C. or higher is performed under the following conditions.
Measurement apparatus: NETZSCH DSC 204F1
Measurement method: heat flux system
Temperature: 25° C.→−80° C.→100° C.
Rate of temperature increase/decrease: 10° C./min
Atmosphere: nitrogen

Sample preparation: A surfactant-containing aqueous coating composition is placed in an empty aluminum pan so as to attain 1 mg in terms of dry solids content, and is allowed to stand still at room temperature to be dried, and it is confirmed that a weight variation from the previous day is 1% or less, thereby obtaining a sample to be measured.
Reference: aluminum pan

### Test Example: Banana

A coating film was formed on a surface of an unripe banana, and the coated banana was subjected to a force-ripening treatment with a gas containing propylene, and the keeping of freshness of the fruit/vegetable and the ripening progress were evaluated.

Bananas in a mature green stage (light green), which were produced in the Philippines, were obtained from an importer, damaged or rotten bananas were removed through visual inspection, and the remaining bananas were washed with ion-exchanged water before the test, and then used.

### Freshness Keeping Evaluation

As the ripening of bananas progresses, the saccharification of the bananas proceeds, and the bananas become sweet and become soft, and thus become suitable for eating. In an unripe state, the pericarp is green, but in a state suitable for eating, it turns yellow.

For the above reasons, in addition to the weight loss rate for confirming transpiration suppression, the freshness keeping and the ripening progress were confirmed by the fruit hardness, the pericarp color, and the color index.

### Weight Loss Rate

The weight loss rate after storage at 20° C. for 6 days was determined by the following equation (1) based on the weight of the bananas before storage (Day 0).

(100−(weight after storage/weight on Day 0)×100 (%)) (1)

Five bananas were used for the evaluation, and an arithmetic mean of the obtained values could be taken as the weight loss rate.

### Fruit Hardness

After storage at 20° C. for 6 days, the bananas were peeled, and a fruit hardness tester equipped with a cylindrical plunger having a diameter of 3 mm was pushed into the banana pulp by 20 mm at a rate of 100 mm/min, and a maximum load (N) was measured. Three bananas were used for the measurement, and the measurement was performed at three different locations per banana, and an arithmetic mean value of the obtained values was taken as the fruit hardness.

### Pericarp Color

After storage at 20° C. for 6 days, the pericarp color of the bananas was visually observed.

### Color Index

After storage at 20° C. for 6 days, the L, a, b values of the pericarp of the bananas were measured using a CR-200B (Konica Minolta, Inc.). Three bananas were used for the measurement. The measurement was performed at three different locations, and an arithmetic mean value was used as the color index.

### Example 1

An aqueous coating composition was prepared by dissolving “Ryoto (trade name) Sugar Ester S-1170” (sucrose stearic acid ester, HLB: 11, monoester content: about 55 mass %, di/tri/polyester content: about 45 mass %) available from Mitsubishi Chemical Corporation as a long-chain fatty acid-based surfactant in water in such a manner that the content of the long-chain fatty acid-based surfactant was 5 mass % at room temperature.

The aqueous coating composition was applied to the surfaces of bananas by a dipping method, and dried by being left to stand at room temperature (from 20 to 25° C.) for 30 minutes to form a coating film. Thereafter, the banana was placed in a sealable plastic vessel and brought into contact with propylene at 5000 ppm at 25° C. overnight to perform a ripening treatment. The obtained fruit was evaluated for weight loss rate, fruit hardness, pericarp color, and color index as described above. The results are shown in Table 1. In addition, in the differential scanning calorimetry at 0° C. or higher, the composition had one endothermic peak having a peak top at 50.40° C. in a range of from 30° C. to 58° C., and A₁/A₂ was 10% or less.

### Comparative Example 1

The evaluation was performed in the same manner as in Example 1 except that no coating film was formed on the surface and no ripening treatment was performed. The results are shown in Table 1.

### Comparative Example 2

The evaluation was performed in the same manner as in Example 1 except that no ripening treatment was performed. The results are shown in Table 1.

### Comparative Example 3

The evaluation was performed in the same manner as in Example 1 except that no coating film was formed on the surface. The results are shown in Table 1.

The configurations and evaluation results of Example 1 and Comparative Examples 1 to 3 are shown in Table 1.

TABLE 1

| | | | | | | Refer- |
|---|---|---|---|---|---|---|
| | | | | | | ence |
| | | | | | | 0 Days |
| | | Example | Comparative Example | | | of |
| 6 Days of storage | | 1 | 1 | 2 | 3 | storage |
| Film coating | | Present | Absent | Present | Absent | — |
| treatment | | | | | | |
| Force-ripening | | Present | Absent | Absent | Present | — |
| treatment | | | | | | |
| Weight loss rate (%) | | 4.0 | 8.3 | 3.6 | 7.5 | 0 |
| Freshness keeping | | ∘ | x | ∘ | x | — |
| Fruit hardness (N) | | 1.3 | 8.7 | 9.0 | 1.1 | 8.5 |
| Pericarp | L | 70 | 59 | 56 | 73 | 54 |
| color | a | 3 | −7 | −9 | 7 | −11 |
| | b | 47 | 36 | 34 | 46 | 33 |
| | Appearance | Yellow | Green | Green | Yellow | Green |

| | | | | | |
|---|---|---|---|---|---|
| Ripening progress | ∘ | x | x | ∘ | — |

It is seen from Table 1 that the coated bananas subjected to the force-ripening treatment in Example 1 have a smaller weight loss than those of the uncoated bananas in Comparative Examples 1 and 3. It is also seen that the fruit hardness of the bananas of Example 1 is lower than that of the bananas of Comparative Example 2 which are not subjected to the force-ripening treatment, and that the pericarp color is yellow.

From the viewpoint of the freshness keeping effect as seen from the weight loss and the viewpoint of the ripening progress as seen from the fruit hardness and the pericarp color, it could be confirmed that both the effects of freshness keeping and ripening progress were obtained by providing a coating film on the surfaces of the bananas and further performing the ripening treatment.

### Test Example: Avocado

After a coating film was formed on surfaces of avocados and the avocados were stored at a predetermined temperature for a predetermined period, a force-ripening treatment was performed by bringing ethylene gas as a ripening degree controlling substance into contact with the coated avocados, and the keeping of freshness of the fruit/vegetable and the ripening progress were evaluated. The freshness keeping was judged from the weight loss rate, and the ripening was judged from the fruit hardness and the pericarp color.

### Freshness Keeping Evaluation

As avocados ripen, they soften and their color changes from green to blackish purple. Since these changes are easily understood in avocados and consumers generally evaluate the freshness of the avocados by hardness and color, the freshness keeping effect of avocados was confirmed by the fruit hardness and pericarp color in addition to the weight loss rate for confirming transpiration suppression.

### Weight Loss Rate

The weight loss rate (100−(weight after storage→force-ripening→storage/weight on Day 0)×100 (%)) at the time of storage for 6 days after the force-ripening treatment performed after storage for 5 days at 20° C. and 50% RH was determined based on the weight of avocados before storage (Day 0).

### Fruit Hardness

Four avocados were prepared, and the hardness was evaluated by lightly pressing their surface with a finger.

◯ (good): As hard as or slightly softer than the blank (state on Day 0 of storage), with small deformation even when the surface is pressed.

× (bad): Considerably softer than the blank, with great deformation when the surface is pressed.

The above evaluation was performed before storage (Day 0) and at the time of storage for 6 days after the force-ripening treatment performed after storage for 5 days at 20° C. and 50% RH, and the change in fruit hardness was evaluated according to the following criteria.
A: The proportion of samples that can be evaluated as ◯ (good) is more than 75%.
B: The proportion of samples that can be evaluated as ◯ (good) is more than 50% and 75% or less.
C: The proportion of samples that can be evaluated as ◯ (good) is more than 25% and 50% or less.
D: The proportion of samples that can be evaluated as ◯ (good) is more than 0% and 25% or less.
E: There is no sample that can be evaluated as ◯ (good) (0%).

### Pericarp Color

Four avocados were prepared, and the color change was evaluated according to the following criteria. The evaluation was performed before storage (Day 0) and at the time of storage for 6 days after the force-ripening treatment performed after storage for 5 days at 20° C. and 50% RH, and the change in color was evaluated according to the following criteria.
A: There is no sample whose surface is completely turned to blackish purple (0%), or the proportion of such samples is less than 25%.
B: The proportion of samples whose surface is completely turned to blackish purple is 25% or more and less than 50%.
C: The proportion of samples whose surface is completely turned to blackish purple is 50% or more and less than 75%.
D: The proportion of samples whose surface is completely turned to blackish purple is 75% or more and less than 100%.
E: The surfaces of all samples are completely blackish purple (100%).

### First Test

The coated avocados of Examples 2 and 3 and Comparative Examples 6 and 7 and the uncoated avocados of Comparative Examples 4 and 5 were evaluated for freshness keeping by the weight loss rate, hardness and color.

### Examples 2 and 3 and Comparative Examples 6 and 7

The following materials were dissolved in water in the amounts shown in Table 2 to prepare aqueous coating compositions of Examples 2 and 3 and Comparative Examples 6 and 7.

The aqueous coating compositions of Examples 2 and 3 and Comparative Examples 6 and 7 were applied to the surfaces of avocados by a dipping method, and dried at room temperature (from 20 to 25° C.) for 30 minutes to form coating films. The uncoated avocados were used as Comparative Examples 4 and 5.
S-570: sucrose stearic acid ester, “Ryoto (trade name) Sugar Ester S-570” available from Mitsubishi Chemical Corporation, HLB: about 5, mono-to tri-ester content: 86 mass % or more
S-1170: sucrose stearic acid ester, “Ryoto (trade name) Sugar Ester S-1170” available from Mitsubishi Chemical Corporation, HLB: about 11, mono-to tri-ester content: 94 mass % or more
S-1670: sucrose stearic acid ester, “Ryoto (trade name) Sugar Ester S-1670” available from Mitsubishi Chemical Corporation, HLB: about 16, mono-to tri-ester content: 97 mass % or more

The compositional proportions and evaluation results of Examples 2 and 3 and Comparative Examples 4 to 7 are shown in Table 2.

In the differential scanning calorimetry at 0° C. or higher of the aqueous coating compositions of Example 2 and Comparative Example 6, the composition had one endothermic peak having a peak top at 50.40° C. in a range of from 30° C. to 58° C., and A₁/A₂ was 10% or less.

In the differential scanning calorimetry at 0° C. or higher of the aqueous coating compositions prepared from S-1670 used in Example 3 and Comparative Example 7 in the same manner as in Example 3, the composition had one endothermic peak having a peak top at 50.29° C. in a range of from 8° C. to 62° C., and A₁/A₂ was 10% or less. In the differential scanning calorimetry at 0° C. or higher of the aqueous coating compositions prepared from S-570 used in Example 3 and Comparative Example 7 in the same manner as in Example 3, the composition had one endothermic peak having two peak tops at 50.07° C. and 62.29° C. in a range of from 22° C. to 81° C., and A₁/A₂ was 10% or less. Therefore, it is considered that the mixture of S-1670 and S-570 also has A₁/A₂ of 10% or less.

TABLE 2

| | | | | | Comparative | Comparative | Comparative | Comparative | Reference |
|---|---|---|---|---|---|---|---|---|---|
| | | | Example | Example | Example | Example | Example | Example | 0 Days |
| | | | 2 | 3 | 4 | 5 | 6 | 7 | storage |
| Film coating treatment | | | Present | Present | Absent | Absent | Present | Present | — |
| Surfactant | S-570 | [wt %] | | 0.5 | | | | 0.5 | |
| | S-1170 | [wt %] | 5 | | | | 5 | | |
| | S-1670 | [wt %] | | 4.5 | | | | 4.5 | |
| Additional | Ethanol | [wt %] | | 5 | | | | 5 | |
| component | | | | | | | | | |
| Storage | Storage temperature | (° C.) | 20 | 20 | 20 | 20 | 20 | 20 | — |
| conditions | Storage period | [Days] | 5 | 5 | 5 | 5 | 5 | 5 | — |
| Force- | Presence or absence of | | Present | Present | Absent | Present | Absent | Absent | — |
| ripening | treatment | | | | | | | | |
| treatment | Treatment temperature | (° C.) | 20 | 20 | 20 | 20 | 20 | 20 | |
| Weight loss | 5 Days of storage + | [%] | | | | | | | |
| rate | 6 days after force- | | 3.5 | 4.1 | 14.2 | 13.8 | 4.6 | 5.8 | 0 |
| | ripening treatment | | | | | | | | |
| Freshness keeping | | | ∘ | ∘ | x | x | ∘ | ∘ | — |
| Fruit | 5 Days of storage + | [N] | 6.2 | 6.5 | 6.3 | 4.8 | 12.9 | 12.8 | 63.9 |
| hardness | 6 days after force- | | | | | | | | |
| | ripening treatment | | | | | | | | |
| Pericarp | 5 Days of storage + | L | 21 | 23 | 24 | 25 | 30 | 32 | 31 |
| color | 6 days after force- | a | −1 | 0 | 2 | 1 | −2 | −2 | −4 |
| | ripening treatment | b | 3 | 3 | 1 | 1 | 7 | 8 | 11 |
| | | ΔLab | 13 | 13 | 14 | 13 | 4 | 3 | — |
| | | Appearance | Blackish | Blackish | Blackish | Blackish | Green | Green | Green |
| | | | purple | purple | purple | purple | | | |

| | | | | | | | |
|---|---|---|---|---|---|---|---|
| Ripening progress | ∘ | ∘ | ∘ | ∘ | x | x | — |

As shown in Table 2, the coated avocados of Examples 2 and 3 were superior to the uncoated avocados of Comparative Examples 4 and 5 in all of weight loss rate, fruit hardness, and change in pericarp color, and thus it could be confirmed that the freshness keeping effect was obtained by providing a coating film containing a sugar-based surfactant on the surfaces of the avocados.

The avocados of Comparative Examples 6 and 7, which were not subjected to ethylene treatment, had a low weight loss rate due to film coating treatment, but had high fruit hardness, and had a green pericarp color, and ripening did not proceed. By comparing Examples 2 and 3 with Comparative Examples 4 to 7, it is found that ripening was able to be advanced without significantly impairing the moisture of the fruit by performing the film coating treatment and further performing the ethylene treatment.

### Second Test

The coated avocados of Example 4 and Comparative Example 10 and the uncoated avocados of Comparative Examples 8 and 9 were evaluated for freshness keeping by the weight loss rate, hardness and color. However, the freshness keeping was evaluated by the weight loss rate, hardness and color of those stored for 5 days after the force-ripening treatment performed after storage for 2 days at 20° C. and 50% RH.

### Example 4 and Comparative Example 10

The following materials were dissolved in water in the amounts shown in Table 3 to prepare aqueous coating compositions of Example 4 and Comparative Example 10.

The aqueous coating compositions of Example 4 and Comparative Example 10 were applied to the surfaces of avocados by a dipping method, and dried at room temperature (from 20 to 25° C.) for 30 minutes to form coating films.
S-1170: sucrose stearic acid ester, “Ryoto (trade name) Sugar Ester S-1170” available from Mitsubishi Chemical Corporation, HLB: about 11, mono- to tri-ester content: 94 mass % or more
S-100P: glycerin monostearate, “RIKEMAL (trade name) S-100P” available from Riken Vitamin Co., Ltd.

The compositional proportions and evaluation results of Example 4 and Comparative Examples 8 to 10 are shown in Table 2.

In the differential scanning calorimetry at 0° C. or higher of the aqueous coating compositions of Example 4 and Comparative Example 10, the composition had one endothermic peak having peak tops at 49.2° C. and 65.2° C. in a range of from 43° C. to 71° C., and A₁/A₂ was 0%.

TABLE 3

| | | | Comparative | Comparative | Comparative | | Reference |
|---|---|---|---|---|---|---|---|
| | | | Example | Example | Example | Example | 0 Days of |
| | | | 8 | 9 | 10 | 4 | storage |
| Film coating treatment | | | Absent | Absent | Present | Present | — |
| Surfactant | S-1170 | [wt %] | | | 2 | 2 | |
| | S-100P | [wt %] | | | 3 | 3 | |
| Storage | Storage temperature | (° C.) | 20 | 20 | 20 | 20 | — |
| conditions | Storage period | [Days] | 2 | 2 | 2 | 2 | — |
| Force-ripening | Presence or absence of | | Absent | Present | Absent | Present | — |
| treatment | treatment | | | | | | |
| | Treatment temperature | (° C.) | 20 | 20 | 20 | 20 | |
| Weight loss rate | 2 Days of storage + 5 days | [%] | 9.8 | 6.0 | 2.7 | 2.8 | 0 |
| | after force-ripening treatment | | | | | | |
| Freshness keeping | | | x | x | ∘ | ∘ | — |
| Fruit hardness | 2 Days of storage + 5 days | [N] | 6.0 | 5.4 | 12.0 | 9.2 | 63.9 |
| | after force-ripening treatment | | | | | | |
| Pericarp color | 2 Days of storage + 5 days | L | 20 | 21 | 25 | 22 | 31 |
| | after force-ripening treatment | a | 1 | 2 | −1 | 1 | −4 |
| | | b | 1 | 2 | 4 | 2 | 11 |
| | | ΔLab | 15 | 14 | 10 | 13 | — |
| | | Appearance | Blackish | Blackish | Green | Partly | Green |
| | | | purple | purple | | green | |

| | | | | | |
|---|---|---|---|---|---|
| Ripening progress | ∘ | ∘ | x | ∘ | — |

As shown in Table 3, the coated avocados of Example 4 were superior to the uncoated avocados of Comparative Examples 8 and 9 in all of weight loss rate, fruit hardness, and change in pericarp color, and thus it could be confirmed that the freshness keeping effect was obtained by providing a coating film containing a sugar-based surfactant on the surfaces of the avocados.

The avocados of Comparative Example 10, which were not subjected to ethylene treatment, had a low weight loss rate due to film coating treatment, but had high fruit hardness, and had a green pericarp color, and ripening did not proceed. By comparing Example 4 with Comparative Examples 8 to 10, it is found that ripening was able to be advanced without significantly impairing the moisture of the fruit by performing the film coating treatment and further performing the ethylene treatment.

### Example 5

The coated avocados of Example 5 and the uncoated avocados of Comparative Example 11 were evaluated for freshness keeping by the weight loss rate, hardness and color. The storage period was set to 0 days, and data of the weight, fruit hardness, and pericarp color were obtained at the start of the experiment and after 4 days.

The following materials were dissolved in water at a weight ratio of S-1170/M-100 =20/80 in such a manner that the concentration of nonvolatile components was 5 wt. %, thereby preparing an aqueous coating composition of Reference Example 1.

The aqueous coating composition of Reference Example 1 was applied to the surfaces of avocados by a dipping method, and dried at room temperature (from 20 to 25° C.) for 30 minutes to form a coating film.
S-1170: sucrose stearic acid ester, “Ryoto (trade name) Sugar Ester S-1170” available from Mitsubishi Chemical Corporation, HLB: about 11, mono-to tri-ester content: 94 mass % or more
F-110: sucrose stearic acid ester, “DK Ester (trade name) F-110” available from DKS Co., Ltd., HLB: 11
M-100: glycerin monocaprylate, “POEM (trade name) M-100” available from Riken Vitamin Co., Ltd., HLB: 7.0

The evaluation results of Example 5 are shown in Table 4.

In the differential scanning calorimetry at −80° C. or higher of the aqueous coating composition of Example 5 in which S-1170 was changed to the equivalent product F-110, the composition had one exothermic peak of 17.48 J/g having a peak top at −29.7° C. in a range of from −28° C. to −33° C. during temperature decrease, and an exothermic peak of 19.86 J/g having a peak top at −26.0° C. in a range of from −32° C. to −20° C. during temperature increase. The composition also had an endothermic peak of 59.87 J/g having a peak top at 20.8° C. in a range of from 3° C. to 24° C. and an endothermic peak of 15.98 J/g having a peak top at 27.0° C. in a range of from 24° C. to 32° C. At this time, A₃/A₂ was 49%.

TABLE 4

| | | | | Comparative |
|---|---|---|---|---|
| | | | Example | Example |
| | | | 5 | 11 |
| Film coating treatment | | | Present | — |
| Surfactant | S-1170 | [wt %] | 1 | — |
| | M-100 | [wt %] | 4 | — |
| Storage | Storage | (° C.) | 20 | — |
| conditions | temperature | | | |
| | Storage period | [Days] | 0 | — |
| Force-ripening | Presence or | | Absent | — |
| treatment | absence of | | | |
| | treatment | | | |
| | Treatment | (° C.) | — | — |
| | temperature | | | |
| Weight loss rate | Day 0 | [%] | 100 | 100 |
| | Day 4 | [%] | 3.7 | 5.3 |
| Freshness keeping | | | ∘ | — |
| Fruit hardness | Day 0 | [N] | 64 | 64 |
| | Day 4 | [N] | 32 | 5.4 |
| Pericarp color | Day 0 | L | 31 | 31 |
| | | a | −4 | −4 |
| | | b | 11 | 11 |
| | Day 4 | L | 30 | 26 |
| | | a | 1 | 2 |
| | | b | 4 | 1 |
| | | ΔLab | 8 | 13 |

| | | |
|---|---|---|
| Ripening progress | — | — |

As shown in Table 4, the coated avocados of Example 5 showed a suppressed weight loss rate after an elapse of 4 days, maintained a green pericarp color, and had high hardness. The coated avocados of Example 5 were superior to the uncoated avocados of Comparative Example 11 in all of weight loss, fruit hardness, and change in pericarp color, and thus it could be confirmed that the freshness keeping effect was obtained by providing a coating film containing a sugar-based surfactant on the surfaces of the avocados.

The coated avocados of Example 5 were not subjected to ethylene treatment, but A₃/A₂ was 0%, and, even in Examples 2 to 4 in which the effect of ethylene treatment is not usually expected to be exhibited, the ripening progress by ethylene treatment could be confirmed, and therefore, it is considered that the effect of ethylene treatment was exhibited, of course.

As described above, by using a specific coating film and bringing a coated fruit/vegetable into contact with a ripening degree controlling substance under specific conditions, the ripening degree of the fruit/vegetable can be controlled as necessary while keeping the freshness of the fruit/vegetable.

### INDUSTRIAL APPLICABILITY

According to the present invention, the ripening degree of a fruit/vegetable can be controlled as necessary while keeping the freshness of the fruit/vegetable, and thus the fruit/vegetable can be brought into a state suitable for eating at a retail store or at a consumer's hand in consideration of transportation from a storage, or the like. Thus, the present invention is a technique having a high industrial value.

1. A method for controlling a ripening degree of a coated fruit/vegetable, the method comprising bringing a coated fruit/vegetable having a coating film formed on a surface, into contact with a ripening degree controlling substance, wherein the coating film contains a surfactant containing a long-chain aliphatic group in a chemical structure of the surfactant, and has a ratio of a total endothermic peak area A₁ in a range of 0° C. or higher and 40° C. or lower to a total endothermic peak area A₂ at 0° C. or higher and 80° C. or lower of 50% or less in differential scanning calorimetry with a measurement temperature range of 0° C. or higher.

2. The method for controlling a ripening degree of a coated fruit/vegetable according to claim 1, wherein the surfactant is derived from a polyhydric alcohol.

3. The method for controlling a ripening degree of a coated fruit/vegetable according to claim 1, wherein the surfactant contains a sugar-based surfactant.

4. The method for controlling a ripening degree of a coated fruit/vegetable according to claim 1, wherein the surfactant contains a sugar fatty acid ester.

5. The method for controlling a ripening degree of a coated fruit/vegetable according to claim 1, wherein the surfactant contains a sucrose fatty acid ester.

6. The method for controlling a ripening degree of a coated fruit/vegetable according to claim 1, wherein the long-chain aliphatic group of the surfactant is derived from a saturated aliphatic group.

7. The method for controlling a ripening degree of a coated fruit/vegetable according to claim 4, wherein the surfactant contains 50 mass % or more of a sugar fatty acid ester having 3 or less fatty acid ester groups, when a total amount of the surfactant is 100 mass %.

8. The method for controlling a ripening degree of a coated fruit/vegetable according to claim 1, wherein the surfactant has an HLB of 5 or more.

9. The method for controlling a ripening degree of a coated fruit/vegetable according to claim 1, wherein the coating film has an average film thickness of 0.1 μm or more and 10 μm or less.

10. The method for controlling a ripening degree of a coated fruit/vegetable according to claim 1, wherein the coating film has a ratio of a total exothermic peak area A₃ to the total endothermic peak area A₂ at 0° C. or higher and 80° C. or lower of 50% or less in differential scanning calorimetry with a measurement temperature range of −80° C. or higher.

11. The method for controlling a ripening degree of a coated fruit/vegetable according to claim 1, wherein the coating film has a crystal melting peak temperature of 40° C. or higher and 80° C. or lower.

12. A method for controlling a ripening degree of a coated fruit/vegetable, wherein a coating film contains a surfactant containing a long-chain aliphatic group in a chemical structure of the surfactant, and has a ratio of a total exothermic peak area A₃ to a total endothermic peak area A₂ at 0° C. or higher and 80° C. or lower of 50% or less in differential scanning calorimetry with a measurement temperature range of −80° C. or higher.
